(19) United States
(12) Patent Application Publication
(10) Pub. No.: US 2023/0415399 A1
(43) Pub. Date: Dec. 28, 2023

(54) MATERIAL EXTRUSION SYSTEM AND DEVICE USING THE SAME

(71) Applicant: Lionel WINDELS, Genève (CH)

(72) Inventor: Lionel WINDELS, Genève (CH)

(21) Appl. No.: 18/248,743

(22) PCT Filed: Oct. 1, 2021
(86) PCT No.: PCT/EP2021/077181

§ 371 Date: Apr. 12, 2023

(30) Foreign Application Priority Data
Oct. 2, 2020 (EP) 20199865.5
Jan. 25, 2021 (EP) 21153184.3
May 10, 2021 (EP) 21173080.9

(51) Int. Cl. B29C 48/80; B29C 48/25; B29C 48/30; B29C 48/82; B29C 64/209; B29C 64/295

(52) U.S. Cl. CPC B29C 48/802; B29C 48/266; B29C 48/302; B29C 48/82; B29C 64/209; B29C 64/295; B33Y 30/00

(57) ABSTRACT

The present invention relates to a material extrusion head comprising at least one material feeding tube for feeding some extrusion material from one or multiple reservoirs to a heating block, the heating block, which comprises a through-hole and is adapted to generate heat for melting the material to be extruded passing by said through-hole, at least one extrusion nozzle provided at the end of the though-hole of the heating block for outputting the molten material, a support element detachably supporting the heating block and mounted on an extrusion system, and at least one rigid heat break tube portion provided at the end of each of the one or multiple material feeding tube and in contact with said heating block and an actioning system adapted to urge an end of each rigid heat break tube portion against said heating block or directly against the extrusion nozzle so as to provide a sealed extrusion material path.

### TECHNICAL FIELD

The present invention relates to a material extrusion system and more particularly to a material extrusion system for a 3D printing device and even more preferably to a print head using the same for a material extrusion 3D printing device.

### BACKGROUND OF THE ART

Nowadays, 3D printing has become one the most popular process for fabricating objects. 3D printers are additive manufacturing machines that specialize in making custom parts with accuracy. They are classified as “additive” because they build up objects one layer at a time. Specialized software “slices” a 3D model into layers as thin from 0.05 mm for fused printers, to 0.01 mm for SLA processes. These layers are then deposited by the print process, slowly building up a 3D object.

More particularly, 3D printers add material, layer-by-layer, to form a 3D object. This added material can vary among dozens of plastic variations, metal, and even carbon fiber composites which is extruded through a nozzle opening to constitute the layers.

However, when the user desires to change the thickness of the extruded material in order to realize layers with different heights and thicknesses, he has to modify the diameter of the extrusion head output, and be necessarily has to dismantle the end part called the nozzle and change it by another nozzle.

This is a problem caused by the conventional systems because the user needs to change the nozzle each time, be wishes to change the output diameter. This is a difficult and time-consuming work, necessitates to store various types of nozzles and obliges the user to temporarily stop the 3D printing process.

Furthermore, upon change of the nozzle, the user also needs to re calibrate the system. It is as well difficult to remember what nozzle is mounted on the hot end, especially when it gets dirty.

In addition to the above, until now, the major conception of a device to change nozzle hole size is to unscrew it from the heating block, needing strength and a special torque tool, even a spare wrench that may damage connected sensor while holding the heating block. Also, it was needed to lift high the Z axis to access and dismount the nozzle thereby unsealing the material path.

There is therefore a need for a system permitting a modification of the thickness or even the shape of the extruded material without dismantling the extrusion nozzle.

In addition to that, one of the most important aspect in a print head is the thermal management which should provide the best heat to the feeding material.

There is therefore a need for a system permitting a high heat transfer from a heat source to the feeding material.

In addition to that, one of the most important aspect in a print head is the thermal management which should provide a very high thermal resistance between the heat source and the rest of the print head to protect the electronics in the print head.

There is therefore a need for a system permitting a high heat resistance between the heat source and the rest of the print head.

Also, one of the most important aspect in a print head is the thermal management which should provide simultaneously a very high heat transfer from a heat source to the feeding material to melt it and a very high thermal resistance between the heat source and the rest of the print head to protect the electronics in the print head.

There is therefore a need for a system permitting a high heat transfer from a heat source to the feeding material and a high heat resistance from the heat source and the rest of the print head.

Also, since the material is preferably in a liquid or at least a viscous form along the path, it is crucial to have a reliable sealing capacity along the feeding path.

There is therefore also a need for an extrusion system comprising an extrusion head providing high sealing capacity along the material path thanks to the relation between the different elements but also the possible shapes of the elements used.

As mentioned above, dismantling, and then reassembling an extrusion device or a print head using the same constitutes a cumbersome process and lack reliability on ensuring a proper sealing capacity upon reassembling.

There is therefore also a need for an extrusion system comprising an actioning means and/or fixing/fastening means which easily, reliably, and reversibly permit assembling and disassembling an extrusion system.

### SUMMARY OF THE INVENTION

The above problems are solved by the present invention, which is a material extrusion system comprising an arrangement permitting a modification of the thickness or the shape of the extruded material or a modification of the different components without using any type of external tool while ensuring a sealing capacity of the material path along the whole path.

This is achieved thanks to a material feeding tube, which will here be called heat break tube, abutting, or crimped into the heating block or a nozzle mounted on the heating block, instead of being screwed onto the heating block with usually a M6 thread to seal it which permits to reduce the size and weight of the heating block.

Furthermore, when clogs appear, having a thin clamped tube on the heating block makes it difficult to unclog the material without destroying the thin clamped tube There, according to the present invention, the heat break tube is not clamped into the heating block, but it is rather a free mobile part.

The heat break tube is adapted to reduce heat transmission between the heating block and the support portion as only tiny surfaces are in contact. Also, in case of clog or damaged part, it is very simple to dismount and change the heat break tube as it is only abutted and interlocked against two tight parts, i.e. the heating block and the support portion.

Since no tool is needed to dismantle the extrusion head with this arrangement, it reduces the dismantling time.

This abut system with heat break tubes against the heating block can be used to bring multiple tubes very close to each other into one heating block hole and therefore will reduce the unnecessary heating of each material in the heating block when doing a multiple colour part.

A first aspect of the invention is a Material extrusion head comprising at least one material feeding tube for feeding some extrusion material from one or multiple reservoirs to a heating block, the heating block, which comprises a through-hole and is adapted to generate heat for melting the material to be extruded passing by said through-hole, at least one extrusion nozzle provided at the end of the though-hole of the heating block for outputting the molten material, a support element detachably supporting the heating block and mounted on an extrusion system, and at least one rigid heat break tube portion provided at the end of each of the one or multiple material feeding tube and in contact with said heating block and an actioning system adapted to urge an end of each rigid heat break tube portion against said heating block or directly against the extrusion nozzle so as to provide a sealed extrusion material path.

According to a preferred embodiment of the present invention, the support element, the rigid heat break tube portion, and the heating block are detachably mounted together with interlocking elements without any tools needed or screw.

Preferably, the extrusion nozzle consists in a single extrusion nozzle, inserted, fixed, screwed or crimped to the heating block.

Advantageously, the rigid heat break tube portion is provided to abut against the inlet of the through hole of the heating block.

Preferably, the rigid heat break tube abuts and/or crimps directly against the rear portion of the inserted nozzle across the heating block and the through hole.

In addition, a hardened washer with a specific through hole angle would be crimped on the inlet of the through hole of the heating block or nozzle to increase the surface quality and reliability where the heat break tube abuts.

According to a preferred embodiment of the present invention, the extrusion nozzle consists in multiple nozzles disposed on a rotative support detachably attached to the heating block.

Advantageously, the rotative support is detachably attached to the heating block through a threaded mechanism or a clip mechanism, an eccentric lever or the like.

Preferably, the rigid heat break tube portion is provided in the through hole of the heating block to be directly abutting against the rear side of the selected nozzle.

The material extrusion head comprises a reversible locking mechanism configured to lock the rotation of the support, wherein the locking mechanism is the end of the rigid heat break tube portion entering a chamfered portion of the rear size of the nozzle.

Advantageously, the actioning system is a scroll wheel rotating around an axis or an eccentric lever parallel to the moving direction of the rigid material feeding tube portion.

Preferably, the heating block is detachably attached to the support element through the use of intermediary metallic hollow tubes and plates interlocked together.

According to a preferred embodiment of the present invention, the support element is a bored component presenting a through hole transversal to the material feeding direction and adapted to permits passing of a controlled flow of cooling medium through it.

Preferably, the material extrusion head further comprises a fan adapted to send cooling air in the bore of the support element. The bore section element can also be made of plastic

Advantageously, the material extrusion head further comprises a plurality of feeding tubes ending with a plurality of respective rigid heat break tubes and an intermediary element adapted to manage the input of one material at a time or mix the material of each feeding tube before entering the heating block wherein the respective rigid heat break tubes are abutting against the intermediary element.

A second aspect of the invention is a printing device comprising the extrusion head according to the first aspect of the invention.

According to a preferred embodiment of the present invention, the device is a 3D printing device.

### BRIEF DESCRIPTION OF THE DRAWINGS

Further particular advantages and features of the invention will become more apparent from the following non-limitative description of the embodiments of the invention which will refer to the accompanying drawings, wherein

FIG. 1 represents a front view of the Heating block and Multiple Nozzles attached to the support and cooling device according to a first embodiment of the present invention,

FIG. 2 represents a side view of the Heating block and Multiple Nozzles attached to the support and cooling device according to a first embodiment of the present invention,

FIG. 3 represents a front view Heating block and Single Nozzle attached to the support and cooling device with fan attached to it according to a second embodiment of the present invention,

FIG. 4 represents a side view Heating block and Single Nozzle attached to the support and cooling device with fan attached to it according to a second embodiment of the present invention.

FIG. 5 represents a view of the Heating block and Single Nozzle attached to the support and cooling device according to a third embodiment of the present invention,

FIG. 6 represents a view Heating block and Single Nozzle attached to the support and cooling device attached to it according to a fourth embodiment of the present invention,

FIG. 7 represents a side view Heating block and Single Nozzle attached to the support according to a fifth embodiment of the present invention.

FIG. 8 represents a side view Heating block and Single Nozzle attached to the support according to a sixth embodiment of the present invention.

FIG. 9 represents a side view Heating block and Single Nozzle attached to the support according to a seventh embodiment of the present invention.

FIGS. 10a and 10b represent a nozzle according to a preferred embodiment of the invention.

### DETAILED DESCRIPTION OF THE INVENTION

The present detailed description is intended to illustrate the invention in a non-limitative manner since any feature of an embodiment may be combined with any other feature of a different embodiment in an advantageous manner.

In the below description the term “lower part” 200 will be used to describe one or more element taken in the group comprising the heating block 3, the nozzle 4, the heat source 33, the thermocouple 32, a support 5 or only lower part of it 51, any intermediary elements provided below the heat break tube 2 and/or the same, and the term “upper part” 100 will be used to describe one or more element taken in the group comprising the outlet of the feeding tube, the feeding tube, any intermediary elements provided above the heat break tube 2, a heat sink 8, a heat sink connector 82, a support element 5 and/or the same.

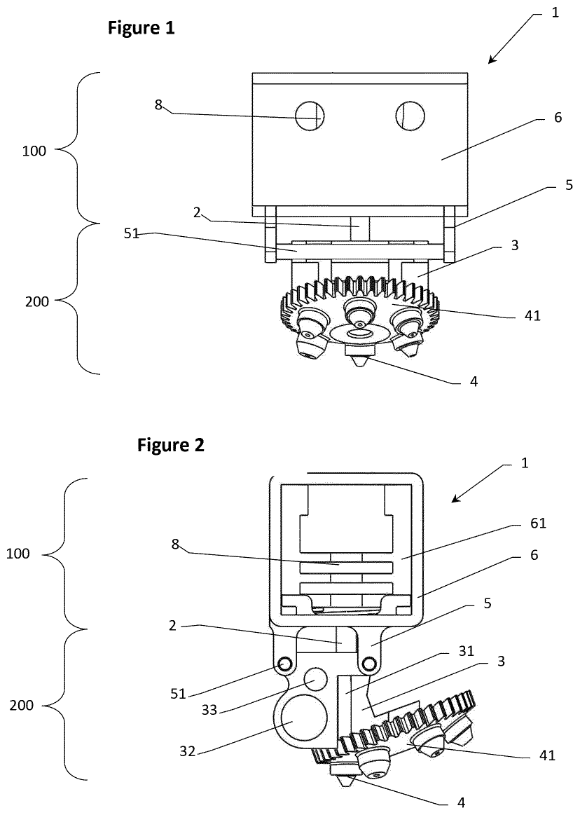

FIGS. 1 and 2 show a first aspect of the invention, which is a material extrusion system or device according to a first embodiment.

The device of the present invention is a material extrusion system 1, preferably a printing head 1 for a 3D printing machine which comprises at least one material feeding tube (not shown but easily imaginable in FIGS. 1 and 2 as a vertical line passing along the center of the device to reach the outlet) for feeding some extrusion material from one or multiple reservoirs (not shown) to a heating block 3 and in the end out of the print head 1. The heating block 3, which comprises a through-hole 31 and is adapted to generate heat, thanks to a heat source 33 and possibly a thermocouple 32, for melting the material to be extruded passing by said through-hole 31, at least one extrusion nozzle 41 provided at the end of the though-hole 31 of the heating block 3 for outputting the molten material, and a support element 5 detachably supporting the heating block 3 and mounted on an extrusion system (not shown). The system can also comprise a heat sink 8 and/or a cooling portion 6.

The material feeding tube can be any tube, preferably made of a soft material for an easy handling of the same which connects a material reservoir to the extrusion system, such as the nozzle 4. Also, the system may (in this embodiment) comprise a tube 2 between the cooling portion 7 or the heat sink 6 and the heating block 3, here below called a heat break tube 2 which will be described later.

The heating block 3 is preferably made of copper or of a thermally conductive metal and preferably comprises two (preferably) horizontal and/or essentially parallel bores 32 so as to be able to receive a heating element 33 and a thermocouple 32. Of course the term heating element means at least one heating element and it is important to note here that bores are not necessarily horizontal but can be vertical, parallel or perpendicular to the material feeding direction.

The heating block 3 is provided with fastening elements 51, preferably two, as shown in FIGS. 1 to 8, capable of fixing it to a support 5 in a detachable manner, also possibly acting as a cooling element, preferably these fastening elements 51 are hollow cylinders, but can have a different shapes such as rectangular plates or tabs, or the same.

FIGS. 1 to 4 show these fastening means 51 in a first configuration where they are essentially horizontal or transversal to the feeding direction and connect legs of a support section 5 to the heating block 3 by being provided within bores of the heating block 3.

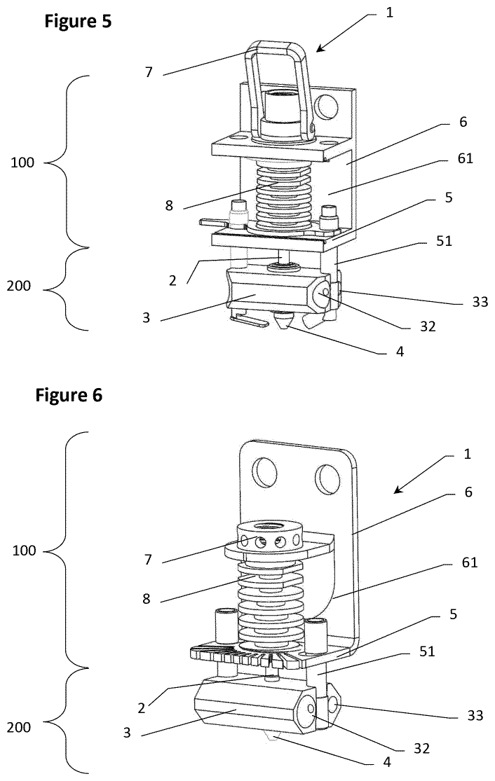

FIGS. 5 to 8 show these fastening means 51 in a second configuration where they are inserted and/or clamped in corresponding receiving portions, for example vertical bores, located on the longitudinal ends of the heating body 3 at one end and are attached and reversibly locked via a clip or clamping means or any other means to the upper part 100 such as a washer 7 or a cooling element 6 on the other end. In this second configuration, they also act as the legs of the support section of the first configuration.

In this second configuration, in addition to be mounted on the heating block 3, these fastening means 51 can lock the heating element 33 and the thermocouple 32 in place if it is expected that the vertical bores, and therefore the fastening means 51, have a diameter or size greater than the distance separating the two (preferably) horizontal bores and therefore cut the path of the heating element 33 and the thermocouple 32 so that once all the elements are mounted on the heating body 3, the heating element 33 and the thermocouple 32 are blocked between the two fastening means 51.

An advantage with these fastening means 51, besides allowing simple locking of the thermocouple 32 and the heating element 33, is to establish a path between the cooling body 7 and the outlet 61 of the extraction head for a cooling fluid. In fact, insofar if they are hollow, they allow passing of a smaller diameter second tube into them and limiting the contact of the hot fixing tube 51 with a flow of cooling air from the cooling body 6 to the outlet of the nozzle 4 to cool the filament of extrusion material directly.

In order to improve such aspect even more, the (preferably hollow) fastening means 51 may be provided with an inner element, preferably a tube, providing the cooling path so as to provide a gap between the inner tube and the fastening means 51 thereby improving the heat isolation between the cooling path and the heating block 3.

Alternatively, the fastening means 51 may have the form of hooks or clamps or the like which have just been attached to slots directly or indirectly provided in the cooling body 6 via a reversible movement of translation and/or rotation.

The heating block 3 also includes one or more central bores for providing a material feeding path to one or more extrusion nozzles 4.

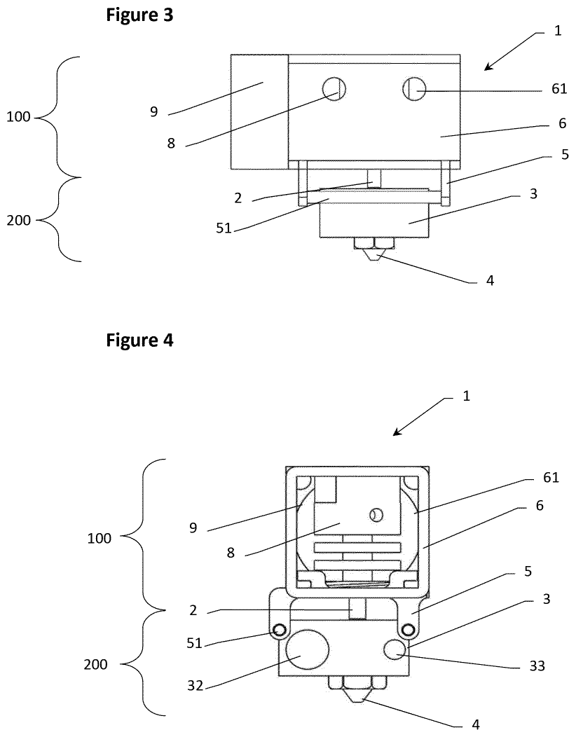

More particularly, as shown in FIGS. 3 and 4, the heating body may be provided with a single nozzle 4 and a single through bore adjoining the nozzle 4 which is crimped or detachably attached or alternatively with several nozzles and several through bores each corresponding to a nozzle, for example to be able to extrude several filaments of material simultaneously or one after the other.

Finally, according to another embodiment depicted in FIGS. 1 and 2, the heating block can be provided with a single through-bore 31 whose end opens onto a nozzle carrousel 41 arranged to be rotated so as to change the nozzle and therefore the extrusion diameter or shape, as described in the application.

According to a preferred embodiment of the invention, as briefly mentioned above, the system 1 comprises a rigid heat break tube 2 provided at the end of the material feeding tube and in contact with the lower part 200, preferably the heating block 3 or the nozzle 4. Of course, in the above-mentioned case where the extrusion head 1 comprises several feeding tubes, each feeding tube shall be provided with such a (preferably rigid) heat break tube 2 unless the system is provided with a system to move the feeding tubes to face successively the same rigid heat break tube 2.

By “at the end of the material feeding tube” two options shall be understood.

In the case where the extrusion nozzle consists in a single extrusion nozzle 4 fixed, screwed or crimped to the heating block 3 or if several nozzles 4 are provided each with their material feeding tube, then the heat break tube 2 is provided to abut against the inlet of the through hole of the heating block or the nozzle depending on the case (see below).

Alternatively, in case of a multiple-nozzle carrousel 41, the rigid heat break tube 2 is preferably provided in the through hole of the heating block 3 to be directly abutting against the rear side of the selected nozzle 4 of the carrousel 41. This permits to the rigid heat break tube 2 to act as a reversible locking mechanism configured to lock the rotation of the carrousel 4, wherein the locking mechanism is the end of the rigid heat break tube 2 entering a chamfered portion of the rear side of the nozzle 4.

As mentioned earlier, the at least one nozzle 4 may be fixed to the heating block 3, directly or indirectly through different ways. For example, it can be screwed to it or crimped to it or the same.

According to a further embodiment, which is possibly a preferred embodiment, the nozzle 4 and at least a portion of the through hole 31 in the heating block 3 have predetermined corresponding shapes permitting to abut against each other such that the nozzle 4 is inserted from the back side (above) of the heating block 3 and abuts against the internal surface of the heating block 3 so as to be adapted to be urged and kept in place by the heat break tube 2 when the heat break tube 2 is actioned so as to abut or to be crimped against the nozzle 41, preferably the back of the nozzle 41.

This arrangement solves the technical problem of providing a very reliable sealing property between the nozzle 4 and the heating block 3 and solves the technical problem of providing a very simple manner of fixing or crimping, the nozzle 4 to/in the heating block 3, without cumbersome fixing step and finally also solves the technical problem of providing an improved heat transfer between the heating block 3 and the extruded material since the nozzle 4 exterior surface is almost entirely in contact with the heating block 3, i.e. preferably the whole outer surface except the outlet end protruding outside the heating block.

According to a preferred embodiment shown in FIGS. 10a and 10b, the nozzle 4 shape can be tapered with a first end being the material input larger than the second send which is the output. Correspondingly, the through-hole 31 in the heating block 3 has a tapered cross section to receive the nozzle 4 which therefore abuts against the inner surface of the through hole with its major part of the surface once in place.

With current models, in order to ensure the tightness of the screwed nozzle against the heat break tube 2, it is often necessary to increase the temperature and re-tighten the nozzle 4 with two tools, to compensate for the thermal expansion of the heating block 3 when it cools. Without this, the risk that the nozzle 41 be free and can leak is important, and the present system offers a better reliability without this drawback since there is preferably no screw.

To prevent the conical nozzle from being too “stuck” in its housing which can be a conical housing at low angle, one can add graphite, in powder or in pencil, this allows it to be dismantled with a slight pressure, while keeping in mind the fact that graphite withstands high temperatures, is a good thermal conductor and has a greasy effect, all of these properties clearly providing an improved contact between the surfaces.

The conical nozzle can be made of several different materials for the same part. For example, a copper or brass part for the body, and the extension in hard steel or with a ruby to make the outlet of the nozzle resistant to abrasion of the filaments and even add, for example, a very thin central steel tube for also strengthen the filament flow area.

With such a type of nozzle, independently of its shape, the heat break tube may alternatively be crimped into the first end of the nozzle (input side). In such a case, the nozzle and the heat break tube form a single component which is detachable from the heating block.

Another element of the head is the support element which is a bored component presenting a through hole transversal to the material feeding direction and adapted to permits passing of a controlled flow of cooling medium through it. In order to do so it can further comprise a fan adapted to send cooling air in the bore of the support element or the heat sink cooling block as support element.

Finally, a further aspect of the invention comprises an actioning system adapted to urge the end of each rigid heat break tube portion against said heating block or directly against the extrusion nozzle so as to provide a sealed extrusion material path.

This actioning system may have different forms, four of which are presented in FIGS. 5 to 8.

It is important to note here that one of the common features is that the function of the actioning system is to at the same time, assemble a lower part with an upper part and tighten the heat break tube between a lower part, possibly comprising the heating block, the nozzle, the heat source, the thermocouple and/or the same, and an upper part, possibly comprising an outlet of the feeding tube, a heat sink, a heat sink connector, a support element and/or the same so as to provide a reliable sealing property along the feeding path. This can be done by lifting the lower part against a stationary upper part.

FIG. 5 shows the actioning system in the form of an eccentric lever attached to the support element via an elastic washer. By (vertically) rotating this lever (manually or automatically), the element 8 (here a heat sink) and the heat break tube are pushed against the upper surface of the heating block or the nozzle.

FIG. 6 shows another embodiment of the actioning system which is in the form of a scroll wheel threadedly attached to the support element and rotating around an axis parallel to the moving direction of the material feeding tube portion. By rotating this wheel (manually or automatically), the element 8 and the heat break tube 2 are pushed against the upper surface of the heating block 3 or the nozzle 4.

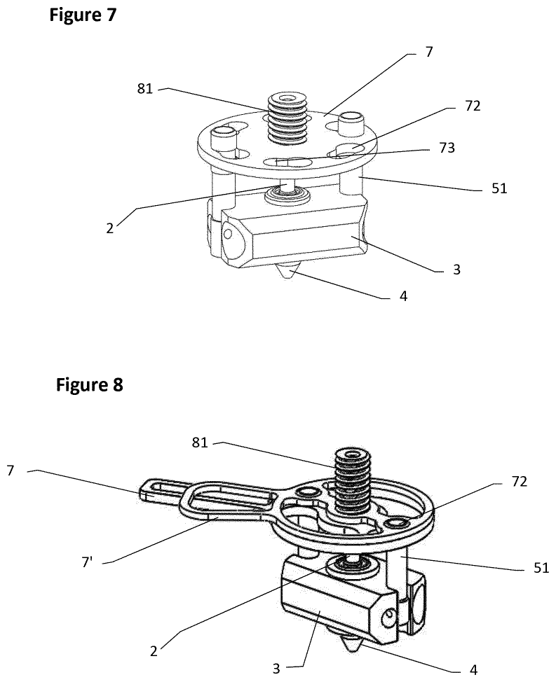

FIG. 7 shows an embodiment which is based on the above one. In this embodiment the device comprises an upper part 100 which is a bored central thread 81, which is destined to be threaded on the extrusion system or a heat sink 8 or the same, is provided with the heat break tube 2 provided on its lower side, and the actioning system 7 in the form of a washer is threaded on its axis to the central thread, like a nut. The washer comprises holes 72 and slots 73, which have a smaller size than the holes, so as to receive and lock the fastening elements 51. Preferably the fastening means are rod-shape like elements, such as tube or similar and present a portion at the upper end which has a smaller diameter to be able to slide into the slots. According to this embodiment, the fastening means 51 are first inserted in the respective holes 72 of the washer until the point where the portion with the smaller diameter is inserted and then the washer is rotated to lock the fastening means in the adjacent slot 73. Then, one turns, preferably counterclockwise, the washer nut together with the heating block and the fastening means with respect to the central thread such that it raises the two fastening means and the heating block 3 such that, in its center, the heat break tube is compressed against the heating block 3. There are therefore three successive movements, one upper (possibly vertical) translation consisting in inserting the fastening means in the holes of the washer, a first rotation consisting in sliding the fastening manes in the slots of the washer and a second rotation movement consisting in rotating the washer (with the lower parts, i.e. fastening means, heating block etc.) to screw it on the upper part.

FIG. 8 is an improvement of the embodiment of FIG. 7 where the device comprises two washers 7, 7′. The lower washer 7 (which is represented here with the longer languet) is the same as the one of FIG. 7 but is further provided with a languet facilitating the rotation, although this can be provided in different forms and can be even avoided if an automatic mechanism is provided. The upper washer 7′ (which is represented here with the shorter languet) is a guiding washer and is provided to help positioning the fastening means 51, here in the forms of tubes but which can be different, in the holes 72 of the lower washer 7 and then is rotated to guide all the fastening means 51 in the slots 73 at the same time, in the same manner as above. Once the fastening means 51 are locked in the slot, both washers are rotated to get screwed on the upper part 100 to urge the heat break tube 2 against the heating block 3 or the nozzle 4 in the same manner as above.

Although not shown, the present invention also comprises a fastening system which is able to clamp the heating block vertically without having to turn an actioner to create the contact of the heat break tube with the heating block (or the nozzle) on one side and with the upper part (heat sink connector or the same), thanks to a lateral clamp system adapted to directly or indirectly (through a support element for example) clamp the heating block and then executes a tightening—approaching process and sliding pulls up of some 1/10th to allow the support and the necessary rigidity to the heating block.

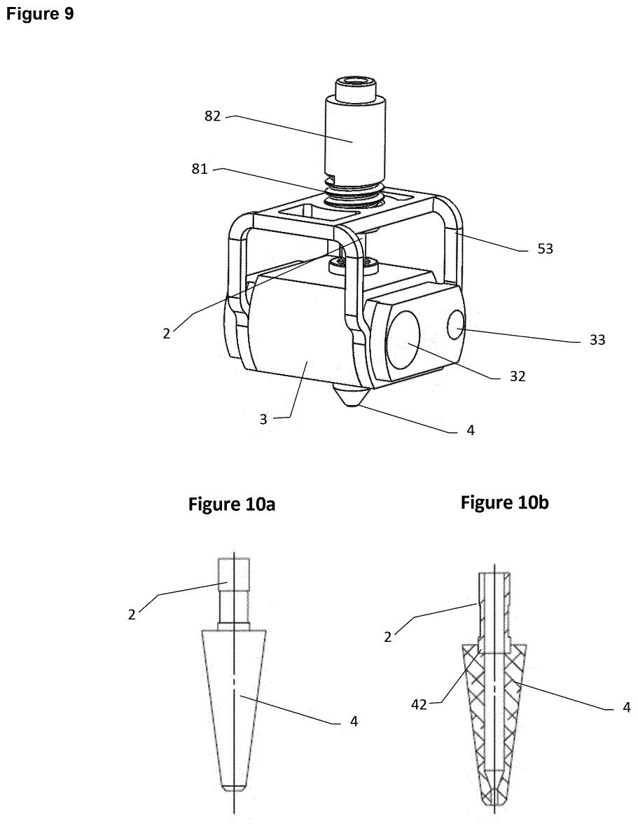

FIG. 9 is an improvement of the embodiment of FIGS. 3 to 8 as the fixing element for the heating block 3 is a single, preferably bended and metallic, bridge part 53.

This bridge part also called bridging element can be fixed to any upper part 100, preferably a heat sink connector 82, by clipping, screwing, sliding, using magnets, bayonet, spring system. FIG. 9 shows a fixing mechanism 81 which presents a threaded relation between the upper part 100 and the bridging element 53 where one can simply screw the bridging element (with the heating block and the lower elements) on the corresponding threaded upper part which permits at the same time to assemble the lower 100 and upper 200 parts and lift the lower part 100 to tighten the heat break tube 2 provided between the upper and lower parts between these two parts and provide sealing capacity along the feeding path. The upper part 100 can be the heat sink 8 or the direct drive that includes a cooling element 6. Furthermore, this bridging element 53 can also have the advantage to lock the heat source (cartridge) 33 and the thermistor cartridge 32, by pressing on the sides of the heating block 3, or at the extremity of the cartridges similar to the tubes (not shown) thus with no screw needed to hold them in place.

FIGS. 10a and 10b represent a tapered nozzle 4 as mentioned above with the heat break tube 2 clipped, abutting or crimped directly into the nozzle, more preferably the back side of the nozzle possibly comprising a recess 42 adapted to match and receive the heat break tube 2. As mentioned, the advantage of a tapered nozzle is that it will naturally be inserted from above the heating block 3 and abut against a corresponding tapered bore provided within a heating block 3 so as to provide a tight contact on a large surface between the nozzle 4 and the heating block 3 thereby permitting an improved heat transfer capacity as well as an improved seal ability. Alternatively, it could also be a cylindrical nozzle 4 inserted from above the heating block 3 with a shoulder at the lower end of the heating block to keep it in position. The heat break tube 2 can be clipped, abutting or crimped-Also the nozzle 4 could also be a screwed nozzle from underneath the heating block 3. According to another embodiment, a spring element or a lever can be provided to push against the heat break tube to maintain the sealing effect between the heat break tube 2, the nozzle 4 and the heating block 3.

A second aspect of the invention is a printing device using the extrusion head described above. Preferably, the printing device is a 3D printing device.

While the embodiments have been described in conjunction with a number of embodiments, it is evident that many alternatives, modifications and variations would be or are apparent to those of ordinary skill in the applicable arts. Accordingly, this disclosure is intended to embrace all such alternatives, modifications, equivalents and variations that are within the scope of this disclosure. This for example particularly the case regarding the diameters used, the shape of the support, the type of fixing mechanism, the material extruded, the material and coating of the nozzles and the like.

1. Material extrusion head (1) comprising:
an upper part (100) comprising:
at least one component provided with at least one material feeding tube for feeding some extrusion material from one or multiple reservoirs to a heating block (3), and
a lower part (200) comprising:
the heating block (3), which comprises a through-hole (31) and is adapted to generate heat for melting the material to be extruded passing by said through-hole, and
at least one extrusion nozzle (4) provided with the heating block (3) for outputting the molten material, and
a support element (5) detachably fastening the lower part (200) and the upper part (100), and
at least one rigid heat break tube portion (2) including a feeding path and provided between the upper and lower parts (100, 200) and an actioning system (7) adapted to displace at least one of the upper and lower parts (100, 200) so as to tighten the heat break tube (2) between the upper and lower parts (100, 200).

2. Material extrusion head according to claim 1, characterized in that the upper part (100) comprises at least one of an outlet of the material feeding tube, a heat sink connector (81), a heat sink (8), a support (5), an actioner (7), a wafer (71), the electronics, the reservoirs, and the same.

3. Material extrusion head according to claim 1, characterized in that the lower part comprises at least one of the heating block (3), the one or more extrusion nozzle (4), fastening means (51), and the same.

4. Material extrusion head according to claim 1, characterized in that actioning system (7) is adapted to urge an end of each rigid heat break tube (2) against said heating block (3) or directly against the extrusion nozzle (4) so as to provide a sealed extrusion material path.

5. Material extrusion head according to claim 1, characterized in that the support element (5), the rigid heat break tube (2), and the heating block (3) are adapted to be detachably mounted together with interlocking elements (51) without any tools needed or screw.

6. Material extrusion head to claim characterized in that the rigid heat break tube (2) is provided to abut against the inlet of the through hole (31) of the heating block (3).

7. Material extrusion head to claim characterized in that the at least one extrusion nozzle (4) is provided within or at the end of the through hole (31) of the heating block (3) for outputting the molten material.

8. Material extrusion head to claim 1, characterized in that the extrusion nozzle (4) consists in a single extrusion nozzle fixed, clipped, screwed or crimped to the heating block (3).

9. Material extrusion head to claim characterized in that the at least one extrusion nozzle (4) has a tapered shape, and the heat block (3) has a corresponding tapered bore adapted to receive said tapered nozzle.

10. Material extrusion head to claim 1, characterized in that the nozzle (4) has a cylindrical shape and the heating block (3) has a shoulder at the lower end to keep it in position.

11. Material extrusion head to claim 1, the back side of the nozzle (4) possibly comprising a recess (42) adapted to match and receive the heat break tube (2)

12. (canceled)

13. (canceled)

14. (canceled)

15. (canceled)

16. (canceled)

17. (canceled)

18. (canceled)

19. (canceled)

20. Material extrusion head according to claim 3, characterized in that the fastening means (51) have a tube shape with lower diameter portion at one end and are adapted to be inserted into holes within the washer and then slide within a slot in said washer.

21. Material extrusion head according to claim 1, characterized in that the heating block is detachably attached to the support element (5) through the use of intermediary metallic hollow tubes (51) and/or plates interlocked together.

22. Material extrusion head according to claim 1, characterized in that the support element is a bored heat sink cooling block (6) presenting a through hole (61) transversal to the material feeding direction and adapted to permits passing of a controlled flow of cooling medium through it.

24. (canceled)

25. (canceled)

26. (canceled)

27. (canceled)

28. (canceled)

29. (canceled)

30. Printing device comprising:
an extrusion head including:
an upper part (100) including:
at least one component provided with at least one material feeding tube for feeding some extrusion material from one or multiple reservoirs to a healing block (3), and
a lower part (200) including:
the heating block (3), which comprises a through-hole (31) and is adapted to generate heat for melting the material to be extruded passing by said through-hole, and
at least one extrusion nozzle (4) provided with the heating block (3) for outputting the molten material, and
a support element (5) detachably fastening the lower part (200) and the upper part (100), and
at least one rigid heat break tube portion (2) including a feeding path and provided between the upper and lower parts (100, 200) and an actioning system (7) adapted to displace at least one of the upper and lower parts (100, 200) so as to tighten the heat break tube (2) between the upper and lower parts (100, 200).

31. (canceled)
